(19) United States
(12) Patent Application Publication
(10) Pub. No.: US 2025/0060550 A1
(43) Pub. Date: Feb. 20, 2025

(54) ADAPTOR ASSEMBLY FOR TELECOMMUNICATIONS MODULE

(71) Applicant: AFL Telecommunications LLC, Duncan, SC (US)

(72) Inventors: Aran James Russell Davidson, Chesham (GB); Asher Leong Raven, Milton Keynes (GB)

(21) Appl. No.: 18/719,960

(22) PCT Filed: Dec. 14, 2022
(86) PCT No.: PCT/US2022/052776

§ 371 Date: Jun. 14, 2024

Related U.S. Application Data
(60) Provisional application No. 63/400,109, filed on Aug. 23, 2022.
(60) Provisional application No. 63/400,202, filed on Aug. 23, 2022.
(60) Provisional application No. 63/289,278, filed on Dec. 14, 2021.

(51) Int. Cl. G02B 6/44

(52) U.S. Cl. CPC G02B 6/44526; G02B 6/44528; G02B 6/4455

(57) ABSTRACT

An adaptor assembly for a telecommunications module. The adaptor assembly includes a carrier having a pair of side- walls and a lateral wall extending between the pair of sidewalls. The sidewalls include a first detent and a second detent distal to the first detent. The first detent forms an open position of the carrier extending from the telecommunications module, and the second detent forms a closed position of the carrier extended into the telecommunications module. The carrier is configured to receive a telecommunications adaptor between the pair of sidewalls and the lateral wall.

### PRIORITY STATEMENT

The application claims the benefit of priority to U.S. Provisional Patent Application Ser. No. 63/289,278, filed on Dec. 14, 2021, and U.S. Provisional Patent Application Ser. No. 63/400,109, filed on Aug. 23, 2022, and U.S. Provisional Patent Application Ser. No. 63/400,202, filed on Aug. 23, 2022, the disclosures of which are incorporated by reference herein in their entireties.

### FIELD

The present disclosure relates generally to telecommunications equipment, and more particularly to systems for mounting and connecting fiber optic cables.

### BACKGROUND

In the fiber optic and telecommunications industry fiber optic connections are spaced closely together in order obtain maximum density. High density fiber optic connections are difficult to latch (connect) and de-latch (disconnect) as they are close together. Close spacing making finger access to the latch or connector body a challenge.

Polarity reversible connections means the connector can be inserted with the latch up or down, giving an increased adaptor height (compared to standard LC adaptors) and connections where the latch of the connector could interfere with one another meaning increased difficulty of latching/de-latching.

Existing solutions including using a connector with a pull tab or pull boot. However, a need exists for the option to use standard connectors while allowing for high density connection of cables and connectors at telecommunications equipment.

Data racks for telecommunications modules utilize standard sizes and heights that are defined by a multiple of “Rack Units” (RU), such as 42 RU, or 45 RU or 48 RU. Mounting of fiber optic panels into data racks include a chassis with mounting brackets and optical equipment (e.g., fiber optic trays, panels, or modules) that mount onto or into the chassis. The chassis itself normally has a top, sides, base, rear and front face creating an enclosed space or chamber for the optical equipment to be contained. Chassis and height are integer denominations of standard RU height.

Mounting a chassis to a rack generally includes lifting and supporting the whole chassis while fixing the chassis to the rack, which can be difficult due to the weight of the chassis or the position (e.g., height) of the chassis within the rack. The chassis base and top have a thickness that can reduce the amount of space available for the optical equipment to fit within an RU space. Such limitations lead to reduced density of telecommunications connections, such as cables and connectors.

Additionally, a significant problem with designing and selling an integrated connectivity platform is the number of dedicated industry-standard sizes (e.g., 1 RU, 2 RU, 4 RU, etc.) that need to be inventoried in order to be able to produce the various configurations required by a variety of customers.

Accordingly, improved connectivity platforms would be advantageous. Specifically, connectivity platforms that address one of more of the above-stated deficiencies would be advantageous.

### BRIEF DESCRIPTION

Aspects and advantages of the invention in accordance with the present disclosure will be set forth in part in the following description, or may be determined from the description, or may be learned through practice of the technology.

An aspect of the present disclosure is directed to an adaptor assembly for a telecommunications module. The adaptor assembly includes a carrier including a pair of sidewalls, and a lateral wall extending between the pair of sidewalls. The sidewalls include a first detent and a second detent distal to the first detent. The first detent forms an open position of the carrier extending from the telecommunications module, and the second detent forms a closed position of the carrier extended into the telecommunications module. The carrier is configured to receive a telecommunications adaptor between the pair of sidewalls and the lateral wall.

Another aspect of the present disclosure is directed to an adaptor assembly for a fiber optic module. The adaptor assembly includes a fiber optic adaptor configured to receive one or more fiber optic cables, and a carrier including a pair of sidewalls. The carrier includes a lateral wall extending between the pair of sidewalls, in which the sidewalls include a first detent and a second detent distal to the first detent. The first detent forms an open position of the carrier extending from the fiber optic module, and the second detent forms a closed position of the carrier extended into the fiber optic module. The carrier is configured to position the fiber optic adaptor between the pair of sidewalls and the lateral wall.

Yet another aspect of the present disclosure is directed to a rack assembly for a telecommunications module. The rack assembly includes a frame extending along a vertical axis, and a pair of sidewalls attachable to the frame and spaced apart from one another along a lateral axis. The sidewalls extend along a longitudinal axis perpendicular to the lateral axis and include a plurality of rails in adjacent arrangement along the vertical axis and extending along the longitudinal axis, the plurality of rails configured to receive a telecommunications module. The plurality of rails is spaced apart along the vertical axis by less than one rack unit and at least one- third rack unit.

Still another aspect of the present disclosure is directed to a fiber optic assembly. The fiber optic assembly includes a fiber optic cassette including an upper panel wall, a lower panel wall, and a panel sidewall extending between the upper panel wall and the lower panel wall. The fiber optic cassette is configured to receive a plurality of fiber optic cables, and includes a mount. A frame extends along a vertical axis, and a pair of sidewalls is attachable to the frame and spaced apart from one another along a lateral axis. The sidewalls extend along a longitudinal axis perpendicular to the lateral axis, and include a plurality of rails in adjacent arrangement along the vertical axis and extending along the longitudinal axis. The plurality of rails is configured to receive a telecommunications module. The plurality of rails is spaced apart along the vertical axis by less than one rack unit and at least one-third rack unit. The mount at the fiber optic cassette is configured to attach to the rail.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of an embodiment of telecommunications rack assembly including a telecommunications module in accordance with aspects of the present disclosure;

FIG. 2 is a perspective view of the embodiment of the telecommunications rack assembly including the telecommunications module of FIG. 1 in accordance with aspects of the present disclosure;

FIG. 3 is a perspective view of the embodiment of the telecommunications rack assembly of FIG. 1 in accordance with aspects of the present disclosure;

FIG. 4 is a perspective view of an embodiment of the telecommunications rack assembly including an embodiment of the telecommunications module in accordance with aspects of the present disclosure;

FIG. 5 is a perspective view of the embodiment of the telecommunications rack assembly including the embodiment of the telecommunications module of FIG. 4 in accordance with aspects of the present disclosure;

FIG. 6 is a perspective view of the embodiment of the telecommunications rack assembly of FIG. 4 in accordance with aspects of the present disclosure;

FIG. 7 is a perspective view of an embodiment of a telecommunications module in accordance with aspects of the present disclosure;

FIG. 8 is an exploded view of an embodiment of a telecommunications adapter assembly for a telecommunications module in accordance with aspects of the present disclosure;

FIG. 9 is a perspective view of the embodiment of a telecommunications adapter assembly of FIG. 8 in accordance with aspects of the present disclosure;

FIG. 10 is a perspective view of an embodiment of a telecommunications adapter assembly for a telecommunications module in accordance with aspects of the present disclosure;

FIG. 11 is a perspective view of an embodiment of a telecommunications module including an embodiment of a telecommunications adapter assembly in a closed position in accordance with aspects of the present disclosure;

FIG. 12 is a perspective view of an embodiment of a telecommunications module including an embodiment of a telecommunications adapter assembly in an open position in accordance with aspects of the present disclosure;

FIG. 13 is a perspective view of an embodiment of a telecommunications module including an embodiment of a telecommunications adapter assembly in accordance with aspects of the present disclosure;

FIG. 14 is a side view of an embodiment of a telecommunications module including an embodiment of a telecommunications adapter assembly in a closed position in accordance with aspects of the present disclosure;

FIG. 15 is a side view of the embodiment of the telecommunications module of FIG. 14 including an embodiment of a telecommunications adapter assembly in an open position in accordance with aspects of the present disclosure;

FIG. 16 is a perspective view of an embodiment of a telecommunications adapter assembly in accordance with aspects of the present disclosure;

FIG. 17 is a perspective view of an embodiment of a telecommunications adapter assembly in accordance with aspects of the present disclosure;

FIG. 18 is a top-down view of an embodiment of a telecommunications module including an embodiment of the telecommunications adapter assembly in accordance with aspects of the present disclosure;

FIG. 19 is an exploded view of an embodiment of a telecommunications module in accordance with aspects of the present disclosure;

FIG. 20 is a perspective view of an embodiment of the telecommunications rack assembly in accordance with aspects of the present disclosure;

FIG. 21 is a perspective view of an embodiment of the telecommunications rack assembly including an embodiment of the telecommunications module in accordance with aspects of the present disclosure;

FIG. 22 is a perspective view of an embodiment of the telecommunications rack assembly including an embodiment of the telecommunications module in accordance with aspects of the present disclosure; and

FIG. 23 is a perspective view of an embodiment of the telecommunications module in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

As used herein, the term “rack unit” (RU) is understood by those skilled in the art as a unit of measure of approximately 1.75 inches (in) or approximately 44.45 millimeters (mm), or up to 0.03125 in or 0.794 mm less when applied to telecommunications equipment attached to a mount structure.

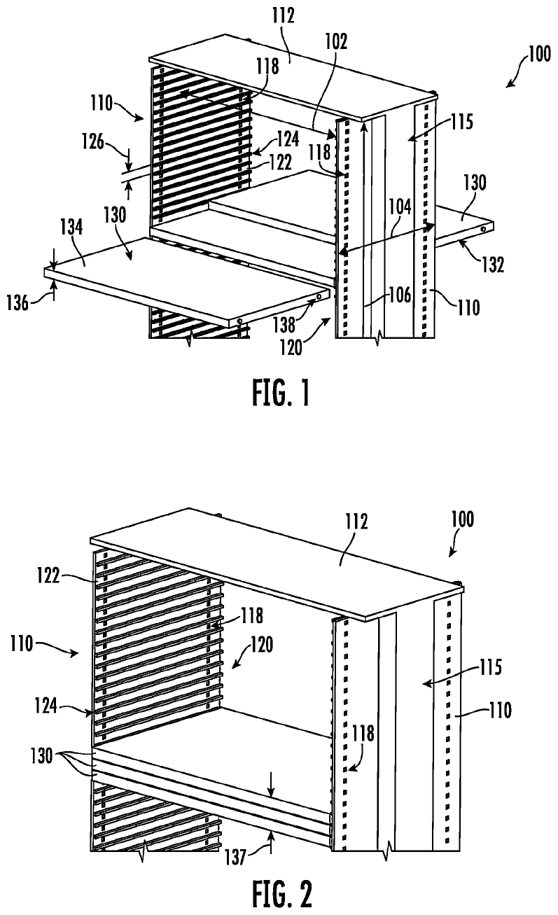

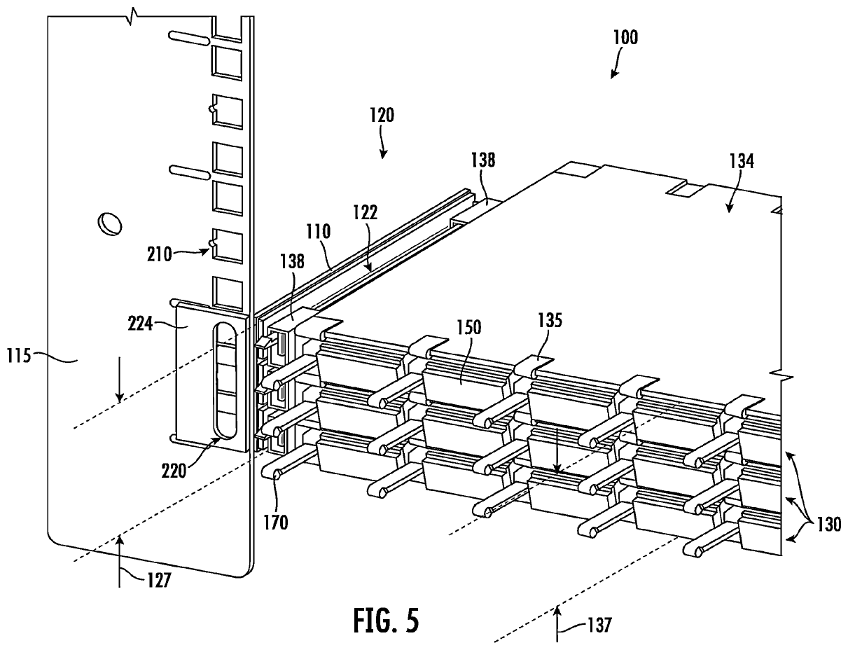

Referring now to the drawings, FIGS. 1-6 provide perspective views of embodiments of a rack assembly for telecommunications modules (hereinafter, “rack 100”). The rack 100 includes a pair of sidewalls 110 spaced apart along a lateral axis 102. Each sidewall 110 extends along a longitudinal axis 104 perpendicular to the lateral axis 102. The longitudinal axis 104 may define a depth of the rack 100 into which a telecommunications module, patch panel, or cassette 130 is positioned within the rack 100. For instance, the cassette 130 may form an interface panel configured to connect multiple fiber optic cables and optical equipment (e.g., adaptors, splice trays, splitters, slack fiber routing, etc.). The sidewalls 110 may be separated along the lateral axis 102 by approximately 19 inches, or approximately 21 inches, or approximately 23 inches, or other appropriate distance, such as to allow the cassette 130 to mount to the rack 100. In various embodiments, the frames 115 may be separate from one another, such as to allow the sidewalls 110 to be spaced apart along the lateral axis 102 by any desired distance. For instance, embodiments of the rack assembly 100 may allow for affixing non-standard sizes of cassette 130 to the rack assembly 100, such as, but not limited to, cassettes 130 of less than approximately 19 inches along the lateral axis 102 (e.g., less than 19 inches between panel sidewalls 132). As depicted in FIG. 1, the cassette 130 is extendable into and out of the rack 100 along the longitudinal axis 104. For instance, a user may install and un-install the cassette 130 at the rack 100 by positioning the cassette 130 into the rack 100 along the longitudinal axis 104 from either a front end or a rear end.

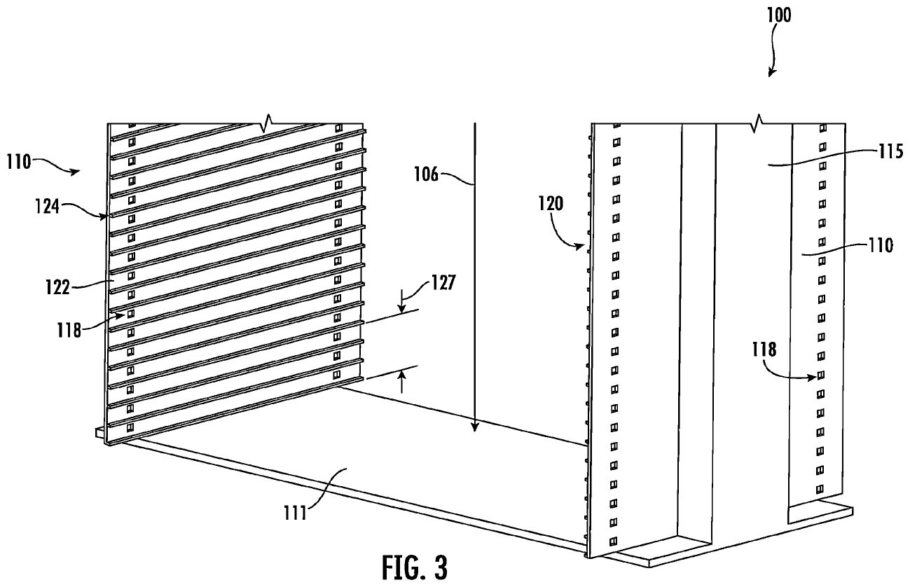

In various embodiments, a frame 115 extends along a vertical axis 106. The pair of sidewalls 110 may mount to the frame 115, such as to provide support to the pair of sidewalls 110 extending along the longitudinal axis 104. In still various embodiments such as described herein, each sidewall 110 extends along the vertical axis 106. An upper wall 112 and a lower wall 111 (FIG. 3) may be positioned at distal ends of the frame 115 along the vertical axis 106, such as to provide an upper and lower casing surrounding an uppermost and lowermost cassette 130 of a plurality of vertically-arranged cassettes at the rack 100.

The rack 100 includes a rack mount 120 positioned at the sidewall 110. The rack mount 120 is configured to support the cassette 130 at the rack 100. Embodiments of the rack mount 120 allow a plurality of cassettes 130 to affix to the rack 100 in adjacent arrangement along the vertical axis 106. The rack mount 120 includes a rail 122 extending along the longitudinal axis 104. In various embodiments, the rack mount 120 includes a plurality of rails 122 in adjacent arrangement along the vertical axis 106. Each rail 122 is positioned at the sidewall 110. For instance, the rail 122 may be integrated to the sidewall 110, such as brazed or welded, fastened (e.g., via screws, bolts, nuts, caged nuts, captive nuts, washers, bushings, tie rods, pins, or other mechanical fastener, or combinations thereof), integrally formed thereto (e.g., molded, forged, additively formed, machined, or other appropriate manufacturing method, or combinations thereof), or combinations thereof. A space or gap 124 extends along the longitudinal axis 104 and separates adjacent rails 122 from one another along the vertical axis 106.

Embodiments of the rack 100 provided herein may allow the cassette 130 to mount or affix directly to the rack 100. For instance, the cassette 130 may directly affix to the rail 122 without requiring a closure, casing, chassis, or other structure surrounding the cassette 130, or plurality thereof.

Referring to FIGS. 1-3, an embodiment of the rack 100 includes rails 122 formed or coupled to the sidewalls 110 in adjacent arrangement along the vertical axis 106. In some embodiments, the sidewall 110 may extend substantially along an entire vertical dimension between the upper wall 112 and the lower wall 111. In other embodiments, the sidewall 110 may include a plurality of sidewalls 110 positioned in adjacent arrangement along the vertical axis 106 between the upper wall 112 and the lower wall 111. For instance, the plurality of sidewalls 110 may each include segments corresponding to a first dimension 127, such as further described herein.

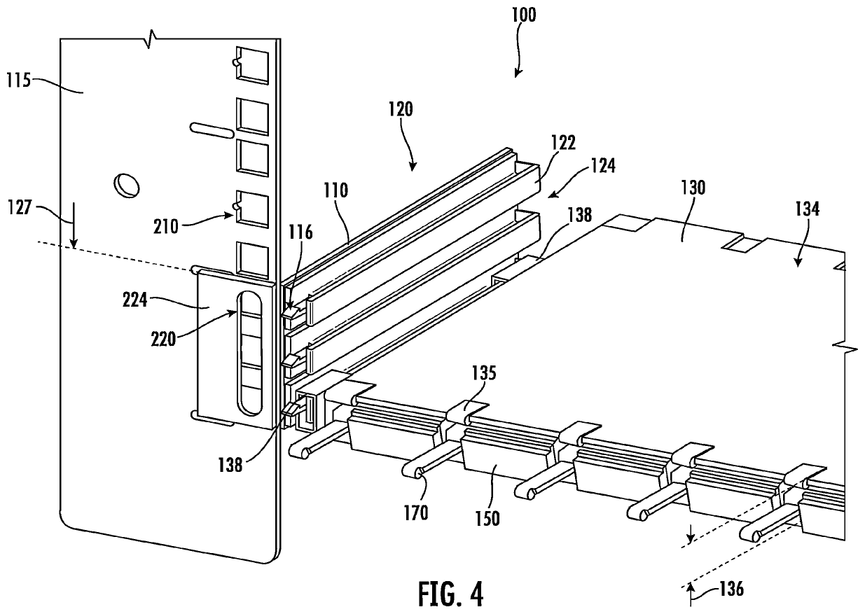

Referring to FIGS. 4-6, an embodiment of the rack 100 includes rails 122 formed or coupled to the sidewalls 110 in adjacent arrangement along the vertical axis 106. The sidewall 110 extends along a portion of the vertical dimension between the upper wall 112 and the lower wall 111. In various embodiments, the sidewall 110 extends along the vertical axis 106 for a first dimension 127, such as one or more rack units (RU). The rack 100 may include a plurality of sidewalls 110 attached to the frame 115 along the vertical axis 106. In such an embodiment, each sidewall 110 may form a one or more RU segment along the vertical axis 106.

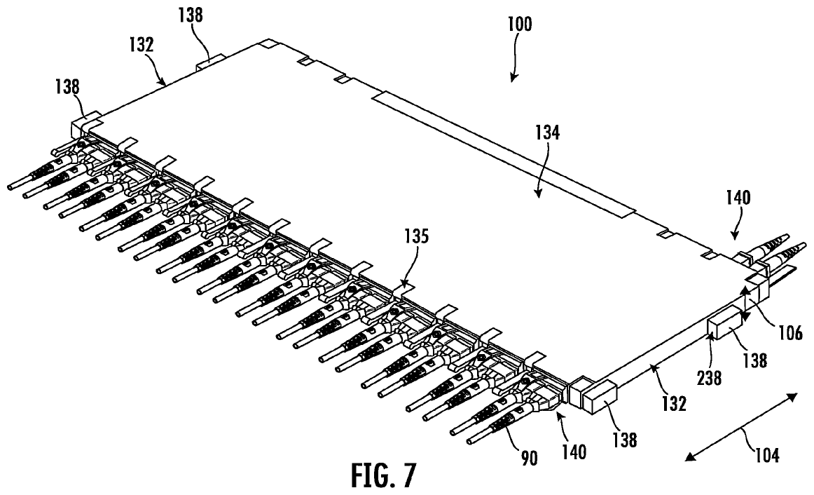

Referring briefly to FIG. 7, and depicted at FIGS. 1-5, perspective views of the embodiments of the cassette 130 are provided. Embodiments of the cassette 130 include upper and lower panel walls 134 extending substantially along the lateral axis 102 and the longitudinal axis 104. Panel sidewalls 132 extend between the upper and lower panel walls 134 substantially along the vertical axis 106 and the longitudinal axis 104. Telecommunications cables 90, such as fiber optic cables, are connectable to the cassette 130 along a front face or rear face extending along the lateral axis 102. In various embodiments, cables 90 include telecommunications adaptors at which connectors attached to the cables 90 are operably connectable.

The cassette 130 includes a mount 138 extending from the panel sidewalls 132. The mount 138 is configured to selectively attach to the rail 122. In various embodiments, the cassette 130 may include two or more mounts 138 each extending from a respective panel sidewall 132. For instance, a first mount 138 may extend from a front end along the longitudinal axis 104, and a second mount 138 may extend from a rear end along the longitudinal axis 104. Referring to FIG. 1, embodiments of the mount 138 may include a pin, such as, but not limited to, a push pin, a removable pin, or mechanical fastener. The mount 138 may extend from the panel sidewall 132 into an opening 118 extending substantially along the lateral axis 102 into the rail 122. Each sidewall 110 may form the opening 118 extending along the lateral axis 102 into the rail 122. In various embodiments, each sidewall 110 forms openings 118 corresponding to front and rear mounts 138 at the cassette 130. In some embodiments, a plurality of openings 118 and a plurality of mounts 138 are formed along the longitudinal axis 104, such as to allow the cassette 130 to affix to the rack 100 in a plurality of positions along the longitudinal axis 104.

Referring to FIGS. 4-7, embodiments of the mount 138 may include a bracket configured to slide or otherwise affix onto the rail 122. For instance, the mount 138 may form a substantially U-shaped or C-shaped rail or slot 238 configured to slide (e.g., along the longitudinal axis 104), press, or snap onto the rail 122 to affix the cassette 130 to the rack 100.

Referring to FIGS. 4-6, embodiments of the rack 100 may include the frame 115 forming a plurality of sidewall mount openings 210 at which the sidewall 110 is releasably attachable to the frame 115. The sidewall mount openings 210 may include square-holed openings, such as to receive caged nuts, or threaded openings, such as to receive screws, bolts, captive nuts, or other appropriate threaded fasteners, or other opening configured to receive a mechanical fastener. The sidewall 110 may include a mount wall 224 forming a plurality of mount openings 220. The mount wall 224 may extend such as to align at least a portion of the mount openings 220 at the mount wall 224 to at least a portion of the sidewall mount openings 210 at the frame 115. In some embodiments, the mount wall 224 extends substantially along the lateral axis 102 such as to align at least a portion of the mount openings 220 to at least a portion of the sidewall mount openings 210. A fastener (e.g., a mechanical fastener) may extend through the openings 210, 220 to affix the sidewall 110 to the frame 115 along a desired position along the vertical axis 106.

In various embodiments, the rack 100 includes the rails 122 arranged along the vertical axis 106 to include a vertical dimension 126 less than one RU. For instance, dimension 126 may be approximately ½ RU or less, such as ⅓ RU. In an embodiment, dimension 126 corresponds substantially to each rail 122 and is approximately ⅓ RU. Accordingly, three (3) vertically adjacent rails 122 correspond to approximately one RU, such as depicted at dimension 127.

In still various embodiments, cassette 130 includes a vertical dimension 136 extending from the upper and lower panels 134. In an embodiment, dimension 136 corresponds substantially dimension 126, such as approximately ½ RU or less, such as ⅓ RU. In an embodiment, dimension 136 corresponds substantially to each rail 122 and is approximately ⅓ RU. Accordingly, (3) vertically adjacent cassettes 130 correspond to approximately one RU, such as depicted at dimension 137.

Embodiments of the rack 100 and rack mount 120 provided herein may allow for eliminating a need for integer RU-delineated enclosures or mount structures. For instance, sub-RU rails 122, such as ⅓ RU, may eliminate a need for a supply chain to accurately forecast a product mix of sizes required by various customers of a manufacturer. By eliminating RU-delineated sized enclosures, a single size rack mount 120 may accommodate any requirement from a customer.

Embodiments of the cassette 130 provided herein may further accommodate a requirement from a customer without regard to integer-RU units. Embodiments of the rack 100 may be configured as any desired height, such as, but not limited to 4 RU along the vertical axis 106, or 3 RU, or 2 RU, or 1 RU, or greater than 4 RU.

Embodiments of sidewall 110 may form separable components that may be brazed, welded, adhered, clamped, or fastened to the frame 115. Sidewall 110 may include a vertical dimension 127 of at least 1 RU, or up to approximately 2 RU, or up to approximately 4 RU, or up to approximately 6 RU. Rails 122 at the sidewall 110 may include a vertical dimension 126 of at least ⅓ RU or less than 1 RU. The vertical dimension 126 may include substantially evenly divided portions of less than 1 RU, such as ⅓ RU, or ½ RU, etc. The sidewall 110 may be configured to receive the cassette 130 at ⅓ RU increment.

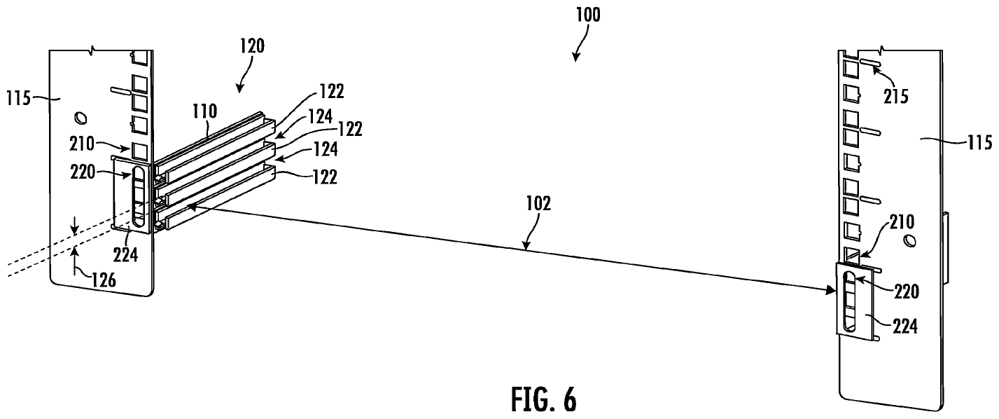

Various embodiments of the rack 100 include the rack mount 120 for mounting optical fiber panels, such as cassette 130, without a chassis for the optical fiber panel(s). The sidewall 110 may form a substantially L-shaped bracket that can be fixed to a profile of a rack 100 with a fastener. The frame 115 may include a first frame portion (e.g., left hand frame) and a second frame portion (e.g., right hand frame), such as depicted in FIG. 6. The sidewall 110 may include a left hand bracket corresponding to the left hand frame 115 and a right hand bracket corresponding to the right hand frame 115 (e.g., depicted in FIG. 6) providing a mounting location for telecommunications modules, patch panels, trays, or cassettes 130 on both sides of the rack 100. The frame portions may allow for desirably adjusting and positioning the distance of the sidewalls 110 along the lateral axis 102 corresponding to any one or more standard sizes of cassette 130, or non-standard sizes, such as, but not limited to, less than approximately 19 inches or greater than approximately 23 inches. The sidewall 110 may include the opening 220 forming a slot extending along the vertical axis 106, such as to allow the cassette 130 to mount at any desired position at the rack 100 within, or out of, the RU sequence. For instance, the cassette 130 may be mounted out of RU sequence as the openings 210 at the frame 115 may be arranged in a repeating pattern that is in sequence with RU denominations (e.g., ⅓ RU, 1 RU, 2 RU, 4 RU, etc.). In some embodiments, the sidewall 110 may be straddled across multiple RU spaces, e.g., ⅓ of 1 RU and 2/3 of 2 RU, etc. In various embodiments, the height of the sidewall 110 is less than 1 RU, such that a plurality of sidewalls 110 per 1 RU may be arranged. In some embodiments, the sidewall 110 may be greater than 1 RU and not in sequence with the integer denominations of RU height.

In various embodiments, the sidewall 110 can be mounted to the frame 115 separately before the cassette 130 is fitted to the rail mount 120. The sidewall 110 has rails 122 that allow cassette 130 to mount directly to the sidewall 110 without the need for a chassis (e.g., surrounding the patch panel, tray, or cassette). The rails 122 may include a latching feature, mechanical lock, or release tab 116 to secure the cassette 130 in position, such as to prevent the cassette 130 from sliding without user articulation. The rails 122 may allow the cassette 130 to be inserted or removed from either the front of the rack 100 or rear of the rack 100 along the longitudinal axis 104.

Embodiments of the rack 100 including sidewalls 110 and rack mounts 120 such as described herein may allow for less RU height space to be wasted, such as to allow for additional cassettes 130 to be placed directly onto the rails 122 at the sidewall 110. Ergonomic issues for users and technicians, such as related to high weight, may be mitigated by allowing sidewalls 110 to be affixed to the frame 115 before installing the cassette 130 to the sidewall 110. Additionally, or alternatively, removing a chassis from around the cassette 130 may lower costs, allow for smaller packaging, and allow for additional cassettes 130 per RU over methods and structures including a chassis surrounding the cassette 130.

Referring now to FIG. 7, a perspective view of a cassette 130 in accordance with aspects of the present disclosure is provided. The cassette 130 includes an adaptor assembly 140 for connecting telecommunications cables 90, such as fiber optic cables, to the cassette 130. The cassette 140 may include a coupling member 135, such as a latch, configured to receive and retain the adaptor assembly 140 in place. The adaptor assembly 140 includes a telecommunications adaptor 150. The adaptor 150 may be configured as a fiber optic connector adaptor, such as, but not limited to, SC, LC, MPO, SN, CS, MU, MDC, or combinations thereof, configured to receive a telecommunications connector 92 attached to a telecommunications cable 90.

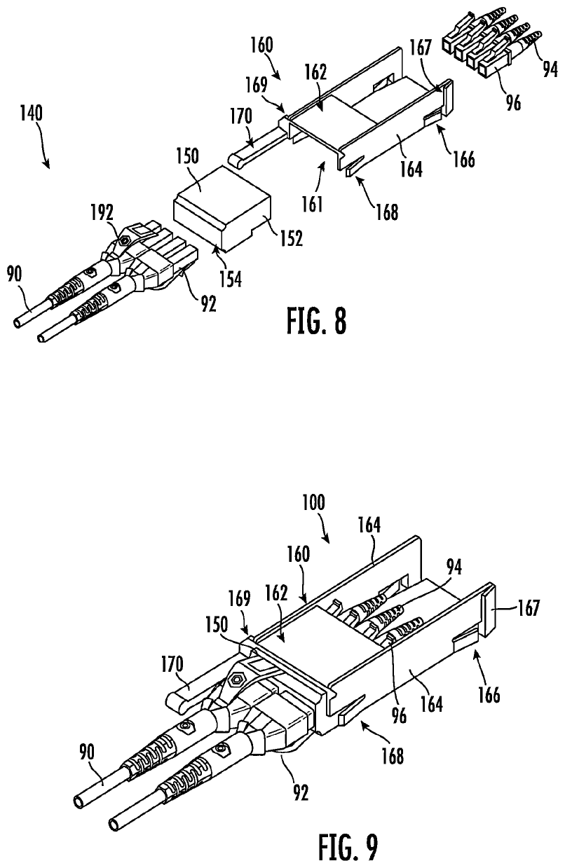

Referring now to FIG. 8, an exploded view of an embodiment of the adaptor assembly 140 is provided. FIG. 9 provides a perspective view of the adaptor assembly 140. The adaptor 150 includes a body 152 forming an opening 154 configured to receive an input or first telecommunications connector 92 from an input or first telecommunications cable 90 and a receiver or second telecommunications connector 96 from a receiver or second telecommunications cable 94. For instance, the cable 94 and connector 96 may be positioned within the cassette 130 and operably connected to one or more splitter modules, splice modules, connectors, or other operational components as may generally be associated with a fiber optic patch panel or cassette. The connectors 92, 96 may include connector latches 192 configured to selectively attach the connectors 92, 96 to the adaptor 150.

The adaptor assembly 140 includes a carrier 160 configured to receive the adaptor 150. The carrier 160 forms a body having a pair of carrier sidewalls 164 extending along a first direction, such as corresponding to the longitudinal axis 104 (FIG. 7). A plurality of cables 90 and connectors 92 (e.g., two or more) may connect into the adaptor 150 between the carrier sidewalls 164. One or more lateral walls 162 extend between the carrier sidewalls 164, such as to connect the sidewalls 164 to one another (e.g., along a second direction, such as the lateral axis 102, perpendicular to the first direction). For instance, the lateral wall 162 may form an upper wall at least partially enclosing the adaptor 150 within the carrier 160.

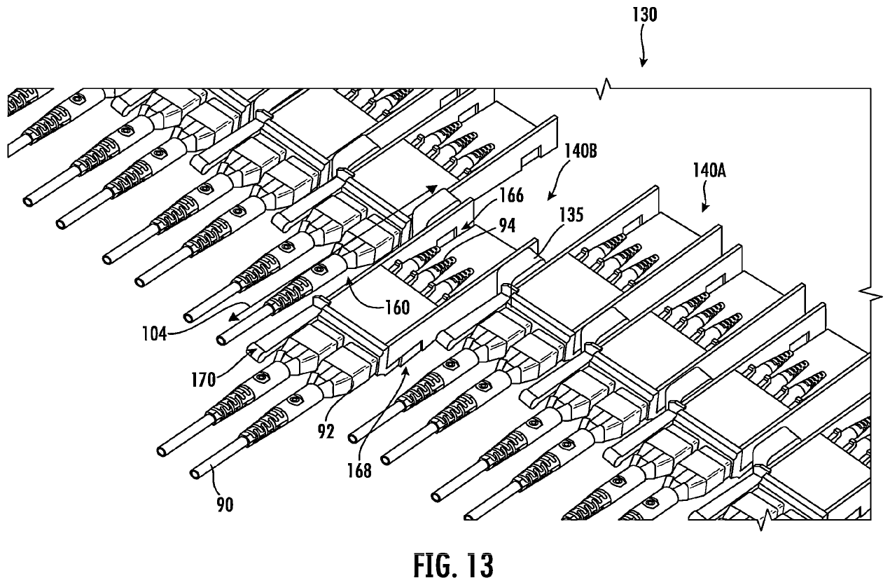

The sidewall 164 may include a first positioning member 166 forming a first lock along the first direction. The first positioning member 166 may include a latch, locking member, or other coupling member configured to selectively attach and detach the carrier 160 to the coupling member 135 at the cassette 130. The sidewall 164 may include a first detent 167 forming a first stop wall along the longitudinal axis 104, such as at a first distal end of the sidewall 164 along the longitudinal axis 104. The first detent 167 may form a protrusion or raised wall configured to stop the carrier 160 along the longitudinal axis 104. In various embodiments, the first detent 167 is positioned at a first distal end of the sidewall 164, such as to form a maximum outward position or open position of the adaptor assembly 140 (e.g., depicted at adaptor assembly 140B in FIG. 12, FIG. 13, FIG. 15).

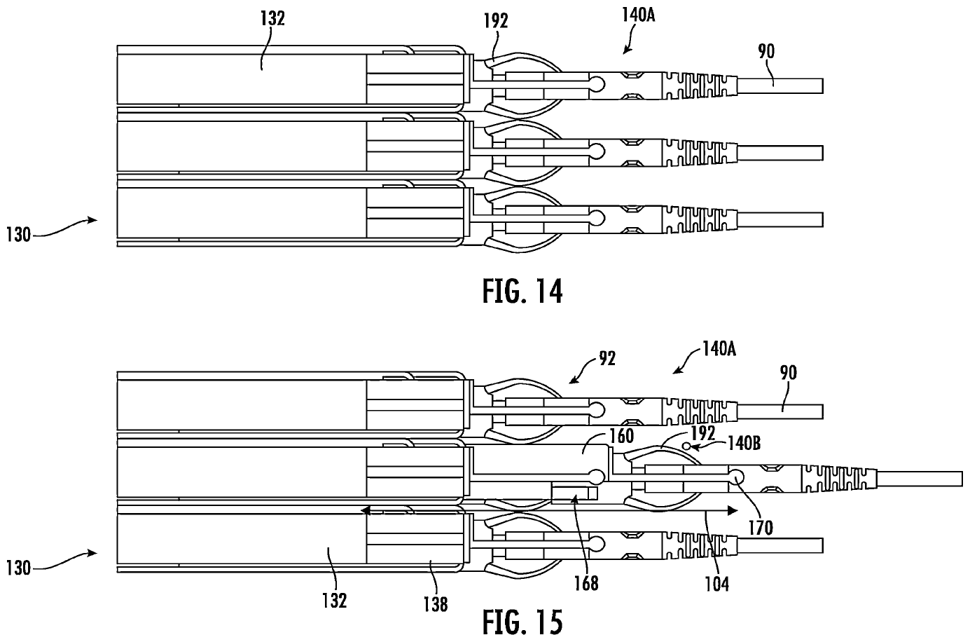

The sidewall 164 may include a second positioning member 168 forming a second lock along the first direction. The second positioning member 168 may include a latch, locking member, or other coupling member configured to selectively attach and detach the carrier 160 to the coupling member 135 at the cassette 130. The sidewall 164 may include a second detent 169 along the first direction opposite of the first detent 167. The second detent 169 may include a protrusion or raised wall configured to stop the carrier 160 along the longitudinal axis 104. In various embodiments, the second detent 169 is positioned at a second distal end of the sidewall 164 opposite of the first distal end, such as to form a maximum inward position or closed position of the adaptor assembly 140 (e.g., depicted at adaptor assembly 140A in FIG. 11, FIG. 13, FIG. 14, FIG. 15).

The positioning members 166, 168 may include flexible, compliant material configured to elastically bend or move to attach and detach from the coupling member 135. For instance, positioning members 166, 168 may be allowed to flex such as to allow the adaptor assembly 140 to selectively translate and affix to a closed position (depicted as adaptor assembly 140A) and an open position (depicted as adaptor assembly 140B). A user may articulate the adaptor assembly 140 by pushing or pulling at an interface tab 170 attached to the carrier 160 and extending therefrom (e.g., along the longitudinal axis 104). Translation of the carrier 160 into the cassette 130 (e.g., depicted at adaptor assembly 140A) and out of the cassette 130 (e.g., depicted at adaptor assembly 140B) may allow for greater density of cables 90 and connectors 92 to the cassette 130 while promoting improved access by a user to secure and release connectors 92 as desired (e.g., at adaptor assembly 140B), such as without disrupting or disconnecting other connectors (e.g., at adaptor assembly 140A). For instance, FIG. 15 depicts the adaptor assembly 140B in an open position, such as to offset the connector latch 192 from adjacent connector latches 192 along the longitudinal axis 104 to facilitate access by the user.

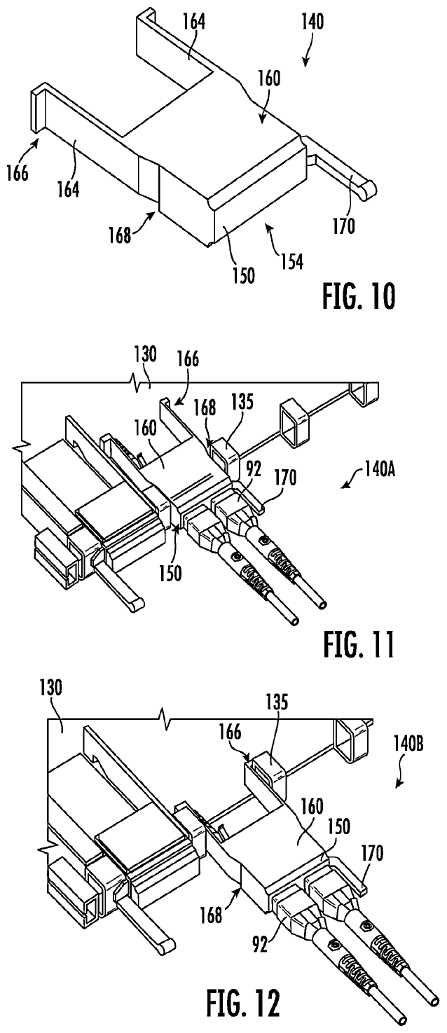

Referring to FIG. 10, and further depicted in FIGS. 11-12, in some embodiments, the carrier 160 and the adaptor 150 may form an integral, unitary, monolithic adaptor assembly 140. In various embodiments, the sidewalls 164 extend from the body of the adaptor 150, such as to further include positioning members 166, 168 such as described herein. The adaptor assembly 140 may be formed from any one or more manufacturing processes and materials (e.g., plastics, metallics, composites, or combinations thereof), such as, but not limited to, an extrusion process, a molding process, a machining process, or any combination thereof.

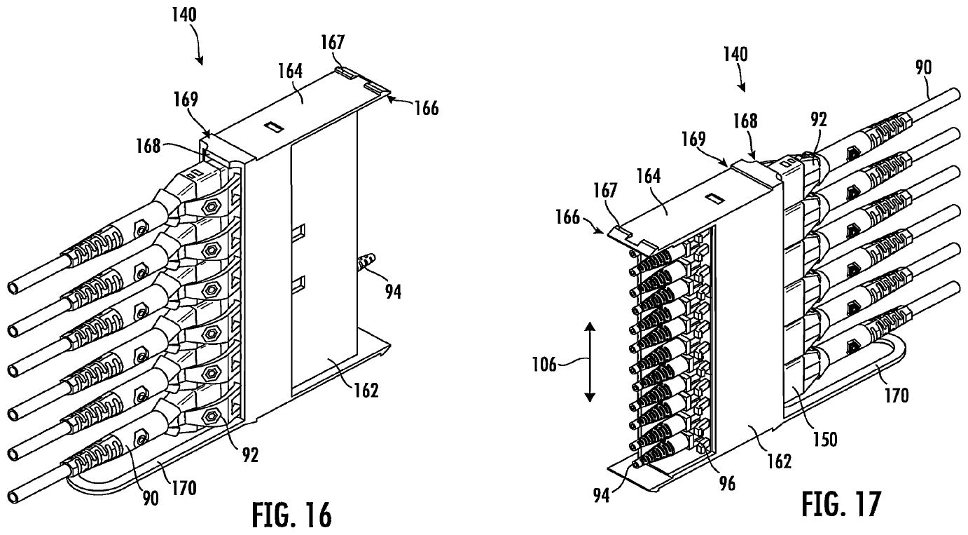

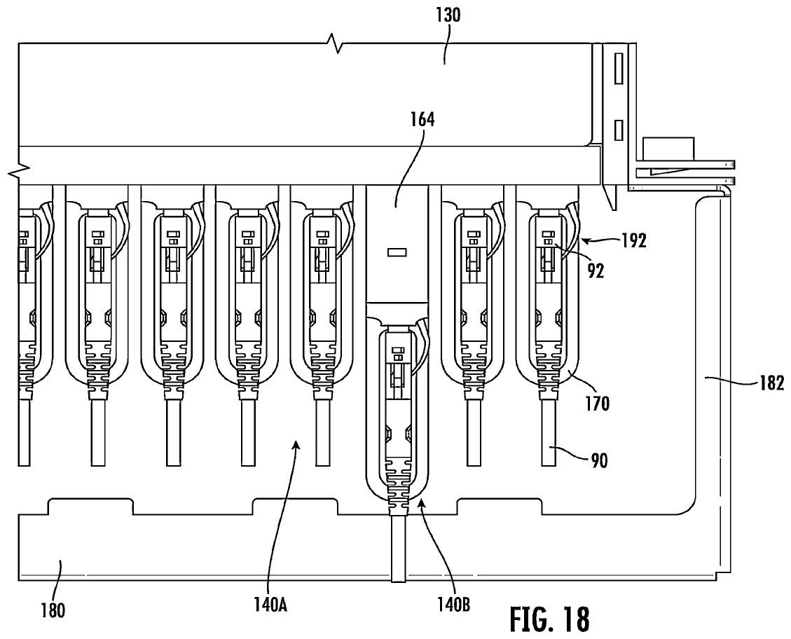

Referring now to FIGS. 16-17, perspective views of an embodiment of the adaptor assembly 140 are provided. In some embodiments, the adaptor assembly 140 may be configured to arrange the plurality of connectors 92 and cables 90 in adjacent arrangement along the vertical axis 106. FIG. 18 provides a top-down view of an embodiment of the adaptor assembly 140, such as provided in FIGS. 16-17, at an embodiment of a cassette 130. The first positioning member 166 may extend away from the lateral wall 162, such as to overhang or cantilever, and allow the first positioning member 166 and first detent to integrate into a single structure. The cantilevered first positioning member 166 may include a raised wall or protrusion and further include a compliant material allowing for selective attachment and detachment to the coupling member 135 such as described herein.

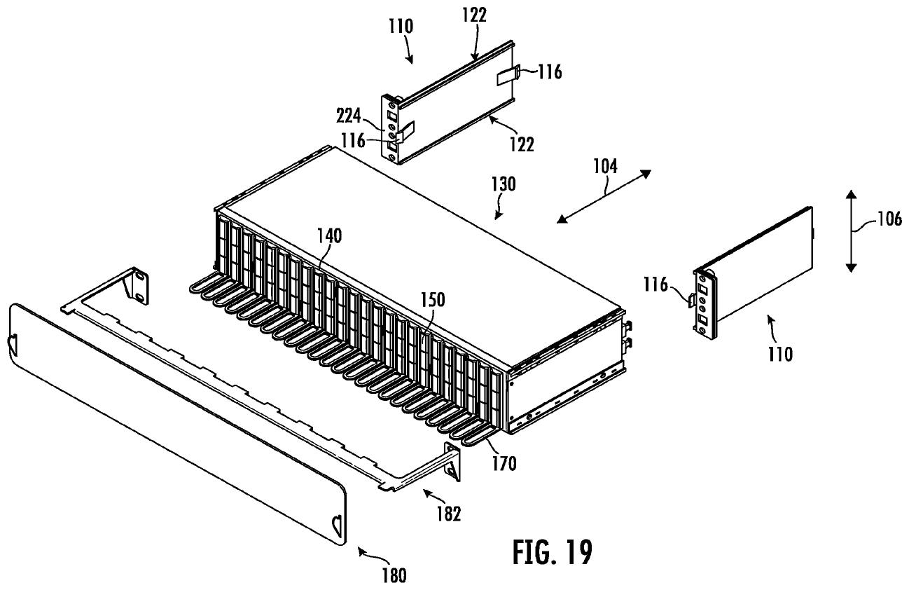

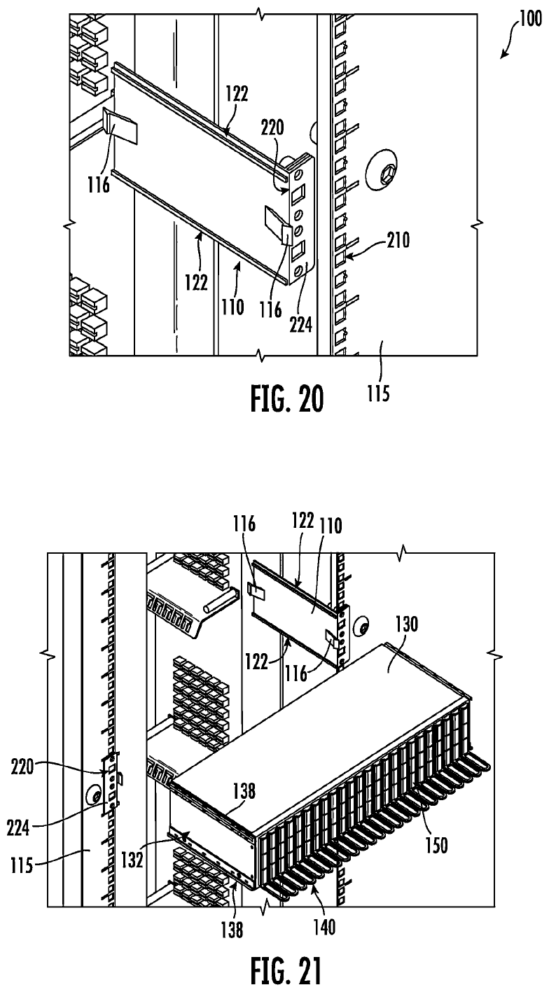

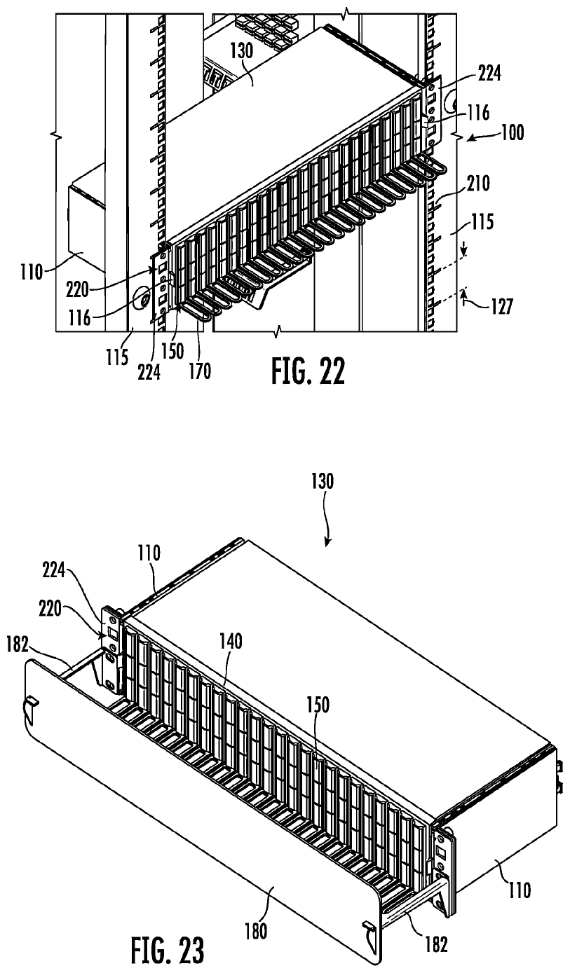

FIG. 19 provides an exploded view of an embodiment of the cassette 130, sidewalls 110, and the adaptor assembly 140 such as described herein. FIGS. 20-23 provide perspective views of a method for assembly of a cassette 130 to a rack 100 in accordance with aspects of the present disclosure. Referring to FIGS. 19-23, the sidewall 110 may be attached to the frame 115, such as described in regard to various embodiments depicted in regard to FIGS. 1-6. The cassette 130 may be attached to the sidewalls 110, such as by sliding mounts 138 at the cassette 130 onto rails 122 at the sidewalls 110. Sidewall 110 may include a release tab 116 at distal ends along the longitudinal axis 104, such as to lock or affix the cassette 130 to the sidewall 110. A user may push the release tab 116 such as to allow the cassette 130 to translate along the longitudinal axis 104.

In some embodiments, a mount member 182 may extend from the sidewall 110 along the longitudinal axis 104. A cover wall 180 may extend along the lateral axis 102 between the mount members 182. The cover wall 180 may extend along a front end, a rear end, or both, such as to provide a protective barrier to the adaptor assembly 140 or interface tabs 170.

Embodiments of the adaptor assembly 140 provided herein may include sliding adaptors or sliding adaptor carriers that allow individual or multiple ports or adaptor banks to slide in a linear direction (e.g., along the longitudinal axis 104 away from front or rear of patch panel or cassette 130) to allow greater finger access to connector housings and latches 192 at the connectors 92, 96 to make connecting and disconnecting fiber optic cables 90 easier for the user. In some embodiments, the carrier 160 may obviate a need for a cover or rear wall, such as to distinguish from a module. Embodiments of the carrier 160 may attach inside the patch panel or cassette 130, and features of the coupling member 135 at the cassette 130 may allow the carrier 160 to seat securely and be actuated by the user.

Embodiments of the adaptor assembly 140 may be utilized for a range of connector/adaptor types, such as, but not limited to, SC, LC, MPO, SN, CS, MU, MDC connectors. Port counts may include, but are not limited to, simplex, duplex, triplex, quadruplex, pentaplex, hexaplex, etc. Embodiments of the adaptor assembly 140 may be mounted in varying orientations, such as, horizontal, vertical, or angled. The adaptor assembly 140 may be used on front face, the rear face, or both, of the patch panel or cassette 130.

Embodiments of the adaptor assembly 140 may provide significant improvement of access to connector bodies 92, and latches 192 thereof, to connect or disconnect fiber optic cables 90. Additionally, or alternatively, advantages of the embodiments provided herein may include moving only one (1) port or adaptor 150 at a time, such as to reduce the risk of moving undesired fiber.

Embodiments of the rack 100 and the adaptor assembly 140 may together allow for significantly increased density of cassettes 130 and telecommunications cables 90 thereto, while further allowing for maintenance and servicing by a user, such as by reducing weight and packaging size and providing translatable structures (e.g., the cassette 130 along the longitudinal axis 104, and furthermore, or alternatively, the carrier 160 along the longitudinal axis 104). Embodiments provided herein, separately or in combination, may advantageously increase connection quantity without disproportionately increasing time to service the increased quantity of connections and equipment.

Further aspects of the invention are provided in the following clauses:

1. A rack assembly for a telecommunications module, the rack assembly including a frame extending along a vertical axis: a pair of sidewalls attachable to the frame and spaced apart from one another along a lateral axis, wherein the sidewalls extend along a longitudinal axis perpendicular to the lateral axis, the sidewalls including a plurality of rails in adjacent arrangement along the vertical axis and extending along the longitudinal axis, the plurality of rails configured to receive a telecommunications module, wherein the plurality of rails is spaced apart along the vertical axis by less than one rack unit and at least one-third rack unit.

2. The rack assembly of any one or more clauses herein, wherein the plurality of rails are evenly spaced from one another along the vertical axis within one rack unit.

3. The rack assembly of any one or more clauses herein, the rack assembly including a plurality of pairs of sidewalls attachable to the frame in adjacent arrangement along the vertical axis.

4. The rack assembly of any one or more clauses herein, wherein the sidewall is approximately one rack unit in dimension along the vertical axis.

5. The rack assembly of any one or more clauses herein, the frame forming a plurality of sidewall mount openings at which the sidewall is attachable to the frame.

6. The rack assembly of any one or more clauses herein, wherein the sidewall forms a mount opening corresponding to at least one of the plurality of sidewall mount openings at the frame, the mount opening and the sidewall mount opening configured to receive a fastener therethrough to retain the sidewall to the frame.

7. The rack assembly of any one or more clauses herein, the sidewall including a mount wall at which the mount opening is formed.

8. The rack assembly of any one or more clauses herein, wherein the mount wall extends along the lateral axis to align one or more mount openings to the sidewall mount.

9. The rack assembly of any one or more clauses herein, wherein the sidewalls are spaced apart along the lateral axis, wherein the lateral spacing is less than approximately 19 inches, or between approximately 19 inches to approximately 23 inches.

10. The rack assembly of any one or more clauses herein, wherein the sidewall includes a release tab configured to selectively affix the telecommunications module to the rail.

11. The rack assembly of any one or more clauses herein, wherein the release tab is positioned at the rail.

12. The rack assembly of any one or more clauses herein, wherein the release tab is positioned at an inside face of the sidewall.

13. A fiber optic assembly, the fiber optic assembly including a fiber optic cassette including an upper panel wall, a lower panel wall, and a panel sidewall extending between the upper panel wall and the lower panel wall, wherein the fiber optic cassette is configured to receive a plurality of fiber optic cables, the fiber optic cassette including a mount: a frame extending along a vertical axis: and a pair of sidewalls attachable to the frame and spaced apart from one another along a lateral axis, wherein the sidewalls extend along a longitudinal axis perpendicular to the lateral axis, the sidewalls including a plurality of rails in adjacent arrangement along the vertical axis and extending along the longitudinal axis, the plurality of rails configured to receive a telecommunications module, wherein the plurality of rails is spaced apart along the vertical axis by less than one rack unit and at least one-third rack unit, and wherein the mount at the fiber optic cassette is configured to attach to the rail.

14. The fiber optic assembly of any one or more clauses herein, wherein the mount forms a slot configured to slide the fiber optic cassette onto the rail at the sidewall.

15. The fiber optic assembly of any one or more clauses herein, wherein the fiber optic cassette is directly mountable to the rails at the sidewalls.

16. The fiber optic assembly of any one or more clauses herein, wherein the plurality of rails are evenly spaced from one another along the vertical axis within one rack unit.

17. The fiber optic assembly of any one or more clauses herein, the rack assembly including a plurality of pairs of sidewalls attachable to the frame in adjacent arrangement along the vertical axis.

18. The fiber optic assembly of any one or more clauses herein, wherein the sidewall is approximately one rack unit in dimension along the vertical axis.

19. The fiber optic assembly of any one or more clauses herein, wherein the sidewall includes a release tab configured to selectively affix the telecommunications module to the rail.

20. The fiber optic assembly of any one or more clauses herein, wherein the fiber optic cassette substantially corresponds in height to the spacing of the rails at the sidewalls.

21. An adaptor assembly for a telecommunications module, the adaptor assembly including a carrier including a pair of sidewalls, the carrier including a lateral wall extending between the pair of sidewalls, wherein the sidewalls include a first detent and a second detent distal to the first detent, and wherein the first detent forms an open position of the carrier extending from the telecommunications module, and wherein the second detent forms a closed position of the carrier extended into the telecommunications module, and wherein the carrier is configured to receive a telecommunications adaptor between the pair of sidewalls and the lateral wall.

22. The adaptor assembly of any one or more clauses herein, wherein the first detent and the second detent form a wall or protrusion each separated from one another along a longitudinal axis.

23. The adaptor assembly of any one or more clauses herein, the carrier including a first positioning member and a second positioning member formed at the sidewalls, wherein the first positioning member and the second positioning member are configured to selectively attach and detach to a coupling member at the telecommunications module.

24. The adaptor assembly of any one or more clauses herein, wherein the first positioning member and the second positioning member form a latch at which the carrier is configured to selectively attach and detach to the telecommunications adaptor.

25. The adaptor assembly of any one or more clauses herein, wherein the sidewalls extend along a longitudinal axis, and wherein the first positioning member and the second positioning member are spaced apart from one another along the longitudinal axis.

26. The adaptor assembly of any one or more clauses herein, wherein the first positioning member and the second positioning member include compliant material configured to elastically bend to attach and detach at the coupling member at the telecommunications module.

27. The adaptor assembly of any one or more clauses herein, wherein the first detent and the first positioning member are an integral component cantilevered from the lateral wall along the longitudinal axis.

28. The adaptor assembly of any one or more clauses herein, the carrier including an interface tab configured to allow a user to translate the carrier into and out of the telecommunications module.

29. An adaptor assembly for a fiber optic module, the adaptor assembly including a fiber optic adaptor configured to receive one or more fiber optic cables: and a carrier including a pair of sidewalls, the carrier including a lateral wall extending between the pair of sidewalls, wherein the sidewalls include a first detent and a second detent distal to the first detent, and wherein the first detent forms an open position of the carrier extending from the fiber optic module, and wherein the second detent forms a closed position of the carrier extended into the fiber optic module, and wherein the carrier is configured to position the fiber optic adaptor between the pair of sidewalls and the lateral wall.

30. The adaptor assembly of any one or more clauses herein, wherein the fiber optic adaptor and the carrier are an integral, monolithic component.

31. The adaptor assembly of any one or more clauses herein, wherein the fiber optic adaptor is for a SC, LC, MPO, SN, CS, MU, MDC fiber optic connector.

32. The adaptor assembly of any one or more clauses herein, wherein the first detent and the second detent form a wall or protrusion each separated from one another along a longitudinal axis.

33. The adaptor assembly of any one or more clauses herein, the carrier including a first positioning member and a second positioning member formed at the sidewalls, wherein the first positioning member and the second positioning member are configured to selectively attach and detach to a coupling member at the fiber optic module.

34. The adaptor assembly of any one or more clauses herein, wherein the first positioning member and the second positioning member form a latch at which the carrier is configured to selectively attach and detach to the fiber optic adaptor.

35. The adaptor assembly of any one or more clauses herein, wherein the sidewalls extend along a longitudinal axis, and wherein the first positioning member and the second positioning member are spaced apart from one another along the longitudinal axis.

36. The adaptor assembly of any one or more clauses herein, wherein the first positioning member and the second positioning member include compliant material configured to elastically bend to attach and detach at the coupling member at the fiber optic module.

37. The adaptor assembly of any one or more clauses herein, wherein the first detent and the first positioning member are an integral component cantilevered from the lateral wall along the longitudinal axis.

38. The adaptor assembly of any one or more clauses herein, the carrier including an interface tab configured to allow a user to translate the carrier into and out of the fiber optic module.

39. The adaptor assembly of any one or more clauses herein, wherein the fiber optic adaptor is configured as a simplex, duplex, triplex, quadruplex, pentaplex, or hexaplex port fiber optic adaptor.

40. The adaptor assembly of any one or more clauses herein, wherein the lateral wall is configured to surround the fiber optic adaptor along a lateral axis perpendicular to the longitudinal axis.

41. The rack assembly of any one or more clauses herein, wherein the sidewalls are spaced apart along the lateral axis, wherein the lateral spacing is less than approximately 19 inches.

42. The rack assembly of any one or more clauses herein, wherein the telecommunications module includes panel sidewalls spaced apart along the lateral axis by approximately 19 inches or less.

43. The rack assembly of any one or more clauses herein, including the adaptor assembly of any one or more clauses herein.

44. A fiber optic cassette, the cassette including the adaptor assembly of any one or more clauses herein.

45. A method for mounting a telecommunications module to a rack assembly, the method including directly affixing the telecommunications module to a rail at a sidewall of the rack assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An adaptor assembly for a telecommunications module, the adaptor assembly comprising:
a carrier comprising a pair of sidewalls, the carrier comprising a lateral wall extending between the pair of sidewalls, wherein the sidewalls comprise a first detent and a second detent distal to the first detent, and wherein the first detent forms an open position of the carrier extending from the telecommunications module, and wherein the second detent forms a closed position of the carrier extended into the telecommunications module, and wherein the carrier is configured to receive a telecommunications adaptor between the pair of sidewalls and the lateral wall.

2. The adaptor assembly of claim 1, wherein the first detent and the second detent form a wall or protrusion each separated from one another along a longitudinal axis.

3. The adaptor assembly of claim 1, the carrier comprising:
a first positioning member and a second positioning member formed at the sidewalls, wherein the first positioning member and the second positioning member are configured to selectively attach and detach to a coupling member at the telecommunications module

4. The adaptor assembly of claim 3, wherein the first positioning member and the second positioning member form a latch at which the carrier is configured to selectively attach and detach to the telecommunications adaptor.

5. The adaptor assembly of claim 3, wherein the sidewalls extend along a longitudinal axis, and wherein the first positioning member and the second positioning member are spaced apart from one another along the longitudinal axis.

6. The adaptor assembly of claim 3, wherein the first positioning member and the second positioning member comprise compliant material configured to elastically bend to attach and detach at the coupling member at the telecommunications module.

7. The adaptor assembly of claim 3, wherein the first detent and the first positioning member are an integral component cantilevered from the lateral wall along the longitudinal axis.

8. The adaptor assembly of claim 1, the carrier comprising an interface tab configured to allow a user to translate the carrier into and out of the telecommunications module.

9. An adaptor assembly for a fiber optic module, the adaptor assembly comprising:
a fiber optic adaptor configured to receive one or more fiber optic cables; and
a carrier comprising a pair of sidewalls, the carrier comprising a lateral wall extending between the pair of sidewalls, wherein the sidewalls comprise a first detent and a second detent distal to the first detent, and wherein the first detent forms an open position of the carrier extending from the fiber optic module, and wherein the second detent forms a closed position of the carrier extended into the fiber optic module, and wherein the carrier is configured to position the fiber optic adaptor between the pair of sidewalls and the lateral wall.

10. The adaptor assembly of claim 9, wherein the fiber optic adaptor and the carrier are an integral, monolithic component.

11. The adaptor assembly of claim 9, wherein the fiber optic adaptor is for a SC, LC, MPO, SN, CS, MU, MDC fiber optic connector.

12. The adaptor assembly of claim 9, wherein the first detent and the second detent form a wall or protrusion each separated from one another along a longitudinal axis.

13. The adaptor assembly of claim 9, the carrier comprising:
a first positioning member and a second positioning member formed at the sidewalls, wherein the first positioning member and the second positioning member are configured to selectively attach and detach to a coupling member at the fiber optic module

14. The adaptor assembly of claim 13, wherein the first positioning member and the second positioning member form a latch at which the carrier is configured to selectively attach and detach to the fiber optic adaptor.

15. The adaptor assembly of claim 13, wherein the sidewalls extend along a longitudinal axis, and wherein the first positioning member and the second positioning member are spaced apart from one another along the longitudinal axis.

16. The adaptor assembly of claim 13, wherein the first positioning member and the second positioning member comprise compliant material configured to elastically bend to attach and detach at the coupling member at the fiber optic module.

17. The adaptor assembly of claim 13, wherein the first detent and the first positioning member are an integral component cantilevered from the lateral wall along the longitudinal axis.

18. The adaptor assembly of claim 9, the carrier comprising an interface tab configured to allow a user to translate the carrier into and out of the fiber optic module.

19. The adaptor assembly of claim 9, wherein the fiber optic adaptor is configured as a simplex, duplex, triplex, quadruplex, pentaplex, or hexaplex port fiber optic adaptor.

20. The adaptor assembly of claim 9, wherein the lateral wall is configured to surround the fiber optic adaptor along a lateral axis perpendicular to the longitudinal axis.
